(19) United States
(12) Patent Application Publication
(10) Pub. No.: US 2005/0152273 A1
(43) Pub. Date: Jul. 14, 2005

(54) Congestion state management device and congestion state management system

(75) Inventor: Tadashi Mimaki, Kawasaki-shi (JP)

Correspondence Address: SUGHRUE MION, PLLC, 2100 PENNSYLVANIA AVENUE, N.W., SUITE 800, WASHINGTON, DC, 20037, US

(73) Assignee: NEC INFRONTIA CORPORATION

(21) Appl. No.: 11/030,114

(22) Filed: Jan. 7, 2005

(30) Foreign Application Priority Data
Jan. 8, 2004 (JP) 2661/2004

(51) Int. Cl. H04L 12/26

(52) U.S. Cl. 370/235

(57) ABSTRACT

In response to receipt of an identification code of a user and a past date that have been input by the user into a congestion state display terminal and transmitted from the congestion state display terminal, a congestion state management device causes the congestion state display terminal to display, as a past graph, congestion rates on that date stored in a memory. The congestion state management device further causes the congestion state display terminal to display, as a using time zone of the user, a period from an entrance time to an exit time of the user on that date stored in the memory.

This application claims priority to prior application JP 2004-2661, the disclosure of which is incorporated herein by reference.

### BACKGROUND OF THE INVENTION

The present invention relates to a congestion state management device that performs congestion state management for a facility, and further relates to a congestion state management system including the congestion state management device and a recording medium recorded therein a program for the congestion state management device.

JP-A-H05-143615 (Patent Document 1) discloses a facility congestion state totalization system that can automatically and precisely totalize the number of users in a facility in real time.

JP-A-2002-239059 (Patent Document 2) discloses a congestion state display system that collects information about waiting times and the numbers of waiting people at a plurality of ski lifts or rest houses in a skiing place and displays it at the entrances of the respective lifts or rest houses.

JP-A-S62-26574 (Patent Document 3) discloses a congestion state monitoring system using a transponder card.

JP-A-H02-244262 (Patent Document 4) discloses an event information management system that can monitor the number of visitors, the state of an event place, and so forth.

JP-A-H04-191795 (Patent Document 5) discloses a congestion state display device for a particular facility in a building.

Any of the foregoing Patent Documents 1 to 5, however, discloses nothing about displaying a past congestion state of a facility and further displaying a using time zone of users of the facility along with the past congestion state.

### DISCLOSURE OF THE INVENTION

It is therefore an object of the present invention to provide a congestion state management device that can display a past congestion state of a facility and simultaneously display even a using time zone of a user of the facility in a display terminal, and further provide a congestion state management system comprising the congestion state management device, and a recording medium recorded therein a program for the congestion state management device.

According to the present invention, there is provided a congestion state management device comprising a processor and a memory that stores a program for causing the processor to execute predetermined processing and also operates as a temporary storage during execution of the program by the processor.

In the congestion state management device according to the present invention, the processor executes, as the predetermined processing, a first step of storing in advance a user capacity number of a facility into the memory as a stored user capacity number; a second step of, responsive to receipt of an entrance time of a user into the facility, an exit time of the user from the facility, and an identification code of the user transmitted from a facility terminal when the user uses the facility, storing the entrance time, the exit time, and the identification code of the user into the memory as stored data by associating them with each other; a third step of processing the stored data by the use of the stored user capacity number to thereby prepare momentary congestion rates of the facility, storing the prepared momentary congestion rates along with a date into the memory, and causing a congestion state display terminal to display the prepared momentary congestion rates along with the date as a graph; and a fourth step of, responsive to receipt of the identification code of the user and a past date that have been input by the user into the congestion state display terminal and transmitted from the congestion state display terminal, causing the congestion state display terminal to display as a past graph the congestion rates on the past date stored in the memory and further causing the congestion state display terminal to display as a using time zone of the user a period from the entrance time to the exit time of the user on the past date stored in the memory.

According to the present invention, there is further provided a congestion state management system comprising a facility terminal provided in a facility, a congestion state management device connected to the facility terminal, and a congestion state display terminal connected to the congestion state management device. The congestion state management device comprises a processor and a memory that stores a program for causing the processor to execute predetermined processing and also operates as a temporary storage during execution of the program by the processor.

In the congestion state management system according to the present invention, the processor executes, as the predetermined processing, a first step of storing in advance a user capacity number of a facility into the memory as a stored user capacity number; a second step of, responsive to receipt of an entrance time of a user into the facility, an exit time of the user from the facility, and an identification code of the user transmitted from a facility terminal when the user uses the facility, storing the entrance time, the exit time, and the identification code of the user into the memory as stored data by associating them with each other; a third step of processing the stored data by the use of the stored user capacity number to thereby prepare momentary congestion rates of the facility, storing the prepared momentary congestion rates along with a date into the memory, and causing a congestion state display terminal to display the prepared momentary congestion rates along with the date as a graph; and a fourth step of, responsive to receipt of the identification code of the user and a past date that have been input by the user into the congestion state display terminal and transmitted from the congestion state display terminal, causing the congestion state display terminal to display as a past graph the congestion rates on the past date stored in the memory and further causing the congestion state display terminal to display as a using time zone of the user a period from the entrance time to the exit time of the user on the past date stored in the memory.

Further, according to the present invention, there is provided a recording medium in which a program has been recorded. The program is for a congestion state management device comprising a processor and a memory that stores the program for causing the processor to execute predetermined processing.

In the recording medium according to the present invention, the predetermined processing comprises a first step of storing in advance a user capacity number of a facility into the memory as a stored user capacity number; a second step of, responsive to receipt of an entrance time of a user into the facility, an exit time of the user from the facility, and an identification code of the user transmitted from a facility terminal when the user uses the facility, storing the entrance time, the exit time, and the identification code of the user into the memory as stored data by associating them with each other, a third step of processing the stored data by the use of the stored user capacity number to thereby prepare momentary congestion rates of the facility, storing the prepared momentary congestion rates along with a date into the memory, and causing a congestion state display terminal to display the prepared momentary congestion rates along with the date as a graph; and a fourth step of, responsive to receipt of the identification code of the user and a past date that have been input by the user into the congestion state display terminal and transmitted from the congestion state display terminal, causing the congestion state display terminal to display as a past graph the congestion rates on the past date stored in the memory and further causing the congestion state display terminal to display as a using time zone of the user a period from the entrance time to the exit time of the user on the past date stored in the memory.

### BRIEF DESCRIPTION OF THE DRAWINGS

FIG. 1 is a block diagram of a congestion state management system according to a preferred embodiment of the present invention;

FIG. 2 is a block diagram of a congestion state management device (server) of the congestion state management system shown in FIG. 1;

FIG. 3 is a diagram for explaining an operation of the congestion state management device (server) of the congestion state management system shown in FIG. 1;

FIG. 4 is a diagram for explaining an another operation of the congestion state management device (server) of the congestion state management system shown in FIG. 1; and

FIG. 5 is a diagram for explaining a still another operation of the congestion state management device (server) of the congestion state management system shown in FIG. 1.

### DESCRIPTION OF THE PREFERRED EMBODIMENT

Now, a preferred embodiment of the present invention will be described with reference to the drawings.

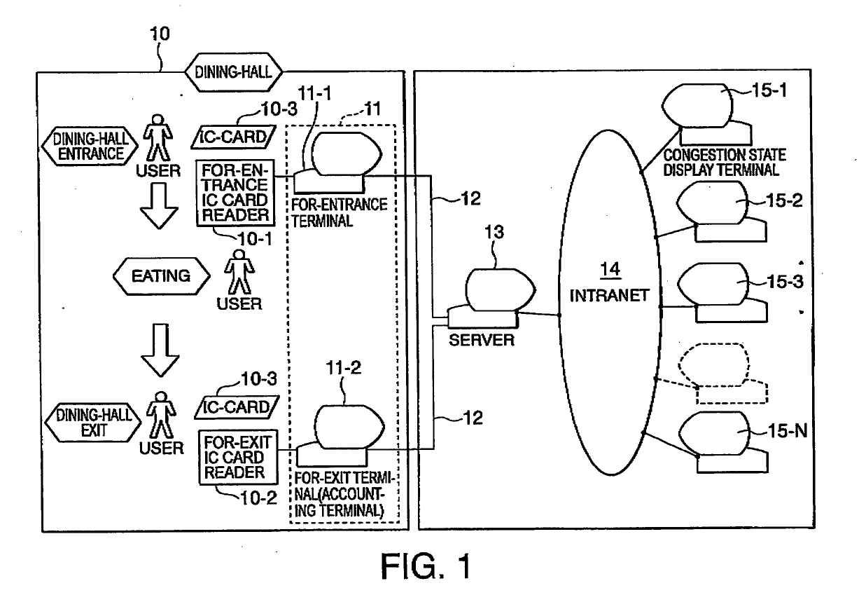

Referring to FIG. 1, description will be made about the embodiment of a congestion state management system, wherein the present invention is applied to a dining-hall as a facility of a company. The congestion state. management system according to this embodiment comprises a facility terminal 11 serving as a computer terminal provided in a dining-hall 10, a congestion state management device (server) 13 connected to the facility terminal 11 via lines 12, and a congestion state display terminal 15-1 connected to the congestion state management device 13 via an intranet 14. The congestion state display terminal 15-1 may be, for example, a computer terminal allocated to each of employees of the company or a computer terminal provided common to employees of the company for displaying congestion states of facilities in the company. As illustrated, like congestion state display terminals 15-2, . . . , 15-N are further connected to the congestion state management device 13 via the intranet 14.

Note that the internet may be used instead of the lines 12 and the intranet 14 shown in FIG. 1.

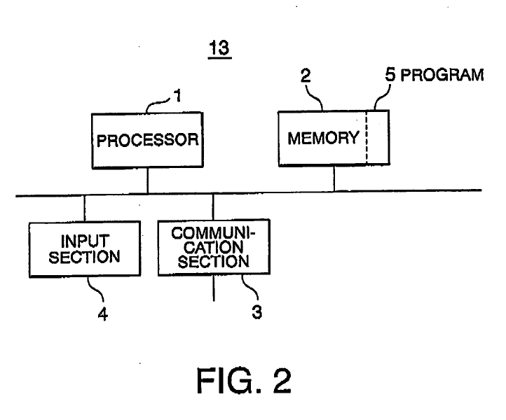

Referring to FIG. 2, the congestion state management device 13 is a computer terminal comprising a processor 1 and a memory 2 that stores a program (program for the congestion state management device) 5 for causing the processor 1 to execute predetermined processing and also operates as a temporary storage during the execution of the program 5 by the processor 1.

The congestion state management device 13 further comprises a key input section 4 and a communication section 3 for communication with the facility terminal 11 and the congestion state display terminals 15-1, . . . , 15-N via the lines 12 and the intranet 14, respectively. The congestion state management device 13 further comprises a display section (not illustrated) in the form of, for example, a liquid crystal display, controlled by the processor 1.

The processor 1 executes the following steps as the foregoing predetermined processing according to the program (program for the congestion state management device) 5 stored in the memory 2.

Specifically, referring also to FIG. 1 in addition to FIG. 2, the processor 1 executes a first step of storing in advance a capacity number of users in the dining-hall (facility) 10 into the memory 2 as a stored user capacity number.

When a user uses the dining-hall 10, an entrance time of the user into the dining-hall 10, an exit time of the user from the dining-hall 10, and an identification code of the user are input into the facility terminal 11. This is realized in the following manner.

Each of users has an IC (integrated circuit) card 10-3 allocated an identification code in advance. A for-entrance IC card reader 10-1 is disposed at the entrance of the dining-hall 10, while a for-exit IC card reader 10-2 is disposed at the exit of the dining-hall 10. The facility terminal 11 comprises a for-entrance terminal 11-1 connected to the for-entrance IC card reader 10-1 and a for-exit terminal 11-2 connected to the for-exit IC card reader 10-2.

When each user enters the dining-hall 10, the IC card 10-3 is read by the for-entrance IC card reader 10-1 and, when each user exits the dining-hall 10, the IC card 10-3 is read by the for-exit IC card reader 10-2. Read-out information is transmitted to the processor 1 from the facility terminal 11.

Then, the processor 1 executes the following processing as a second step. In response to receipt from the facility terminal 11 of the entrance time of the user into the dining-hall 10, the exit time of the user from the dining-hall 10, and the identification code of the user, the processor 1 stores the received entrance time, exit time, and identification code into the memory 2 as stored data by associating them with each other.

Subsequently, the processor 1 executes the following third step. The processor 1 processes the foregoing stored data by the use of the foregoing stored user capacity number to thereby prepare momentary congestion rates of the dining-hall 10. The processor 1 stores the prepared momentary congestion rates along with a date (year, month, day) into the memory 2 and causes each of the congestion state display terminals 15-1, . . . , 15-N to display the prepared congestion rates along with the date as a graph.

Then, the processor 1 executes the following fourth step. In response to receipt of an identification code of a user and a past date that have been input by the user into the congestion state display terminal 15-1 and 10 transmitted from the congestion state display terminal 15-1, the processor 1 causes the congestion state display terminal 15-1 to display as a past graph the congestion rates on that date stored in the memory 2. The processor 1 further causes the congestion state display terminal 15-1 to display as a using time zone of the user a period from an entrance time to an exit time of the user on 15 that date stored in the memory 2.

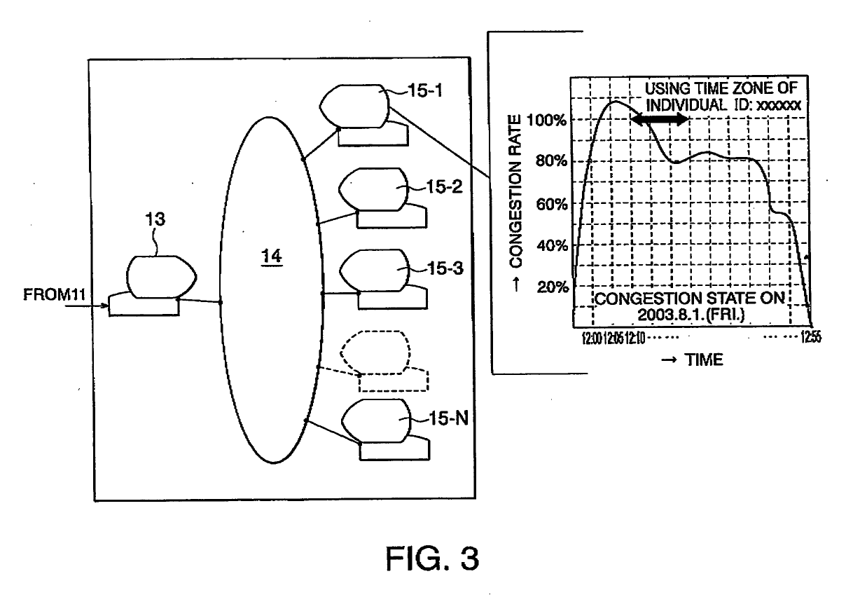

Referring to FIG. 3, description will be given about a preferred example of the foregoing fourth step. In the congestion state management device 13, the processor 1 executes the following processing as the fourth step.

In response to receipt of an identification code of a user and a past date that 2 0 have been input by the user into the congestion state display terminal 15-1 and transmitted from the congestion state display terminal 15-1, the processor 1 causes the congestion state display terminal 15-1 to display as a past graph the congestion rates on that date stored in the memory 2. The processor 1 further causes the congestion state display terminal 151 to display a period from an 25 entrance time to an exit time of the user on that date stored in the memory 2, as a using time zone of the user in the foregoing past graph. Note that the identification code of the user corresponds to INDIVIDUAL ID:xxxxxx in the graph on the right of FIG. 3 and the past date corresponds to 2003.8.1 in the graph on the right of FIG. 3. Further, the using time zone of the user is indicated by a bidirectional arrow in thick solid line in the graph on the right of FIG. 3.

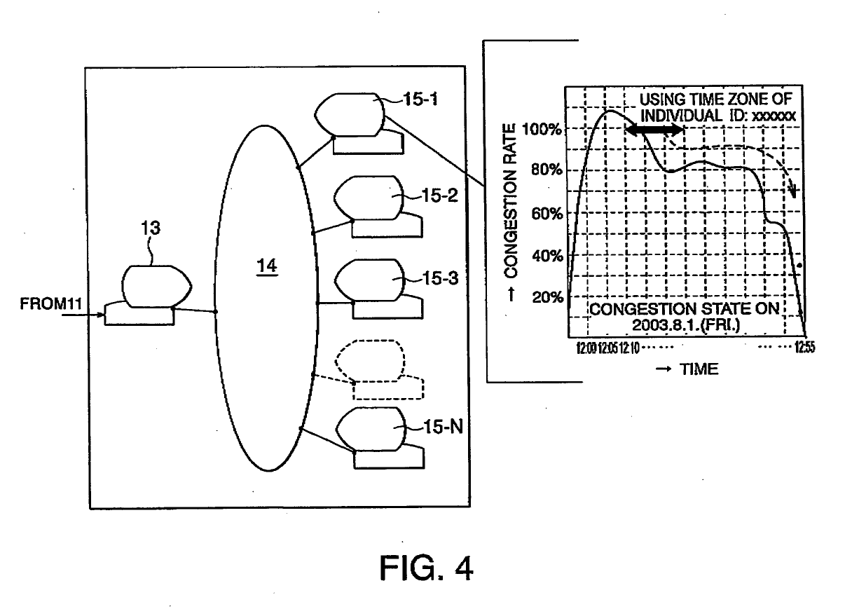

Referring to FIG. 4, description will be given about a more preferred example of the foregoing fourth step. In the congestion state management device 13, the processor 1 executes the following processing as the fourth step. In response to receipt of an identification code of a user and a past date that have been input by the user into the congestion state display terminal 15-1 and transmitted from the congestion state display terminal 15-1, the processor 1 causes the congestion state display terminal 15-1 to display as a past graph the congestion rates on that date stored in the memory 2. The processor 1 further causes the congestion state display terminal 15-1 to display a period from an entrance time to an exit time of the user on that date stored in the memory 2, as a using time zone of the user in the foregoing past graph. Moreover, when the using time zone of the user includes a time zone where the congestion rate exceeds a predetermined congestion rate, the processor 1 executes a step of adding into the past graph an indication recommending use of a non-congested time zone. Note that the identification code of the user corresponds to INDIVIDUAL ID:xxxxxx in the graph on the right of FIG. 4 and the past date corresponds to 2003.8.1 in the graph on the right of FIG. 4. Further, the using time zone of the user is indicated by a bidirectional arrow in thick solid line in the graph on the right of FIG. 4 and the indication recommending use of a non-congested time zone is given by an arrow in thick broken line in the graph on the right of FIG. 4.

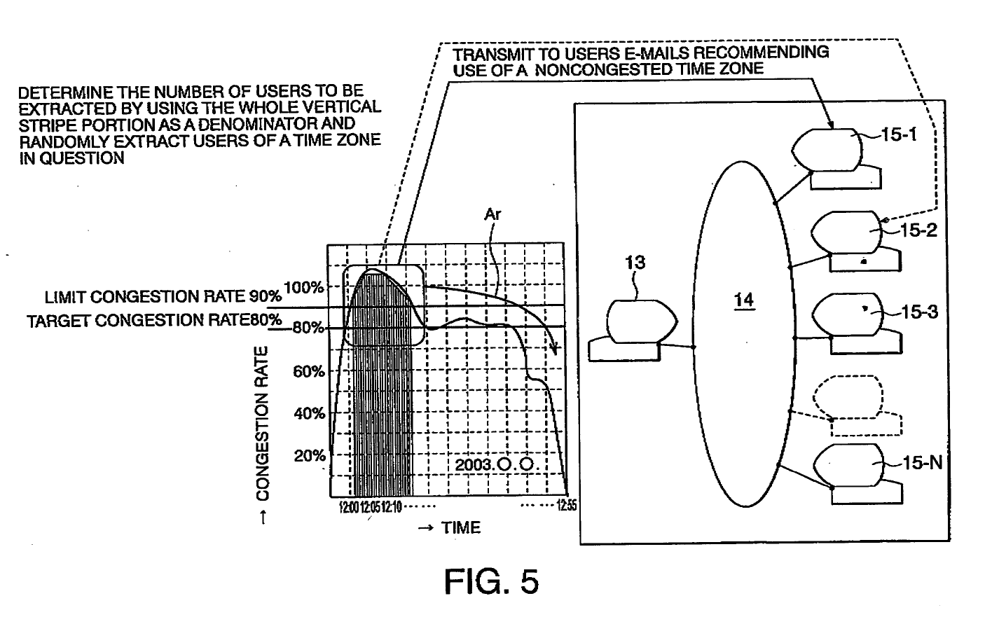

Referring to FIG. 5, description will be given about a most preferred example of the foregoing fourth step. When there is a time zone where the congestion rate of the dining-hall (facility) 10 exceeds a predetermined congestion rate, the processor 1 executes the following processing as the fourth step in the congestion state management device 13. This step is a step of automatically transmitting, on a later date, a notification recommending use of a non-congested time zone to each of the congestion state display terminals 15-1 and 15-2 of the respective users. Specifically, the processor 1 automatically transmits, to at least part of users who used such a time zone (where the congestion rate exceeds the predetermined congestion rate) on that date, for example, to the congestion state display terminals 15-1 and 15-2, a notification by attaching image data in which an indication (a solid line arrow Ar starting from a right side of a square in a graph on the left of FIG. 5) recommending use of a non-congested time zone is added in the graph (on the left of FIG. 5) showing a congestion state on that date along with a using time zone of such users (included between right and left sides of the square indicated in the graph on the left of FIG. 5). Note that the using time zone of such users is the time zone included between the right and left sides of the square indicated in the graph on the left of FIG. 5. Further, the graph showing the congestion state on that date is the graph on the left of FIG. 5, and the indication recommending use of a non-congested time zone is the solid line arrow Ar starting from the right side of the square in the graph on the left of FIG. 5.

As appreciated, the example shown in FIG. 5 can be carried out independently or in combination with the example shown in FIG. 3 or 4.

Now, the foregoing embodiment will be described in further detail.

In the embodiment, the for-entrance IC card reader 10-1 and the for-exit IC card reader 10-2 are provided and, by carrying out reading/writing with respect to an IC card of each user when using the facility, it is possible to grasp the number of users in the facility in real time. Further, the for-entrance terminal 11-1 and the for-exit terminal 11-2 connected to the for-entrance IC card reader 10-1 and the for-exit IC card reader 10-2, respectively, are connected to the server 13 and the information processing is carried out by the server 13 so that the current and/or past congestion states/state of the dining-hall 10 can be known by the use of each congestion state display terminal connected to the server 13 via the intranet 14. Further, it is possible for each facility user to retrieve and display a time when he/she used the dining-hall 10 so that information for relieving the congestion can be offered to the user side.

As described before, in FIG. 1, the for-entrance IC card reader 10-1 and the for-exit IC card reader 10-2 that perform reading/writing with respect to an IC card are disposed at the entrance and the exit of the dining-hall (facility) 10, respectively. The for-entrance IC card reader 10-1 and the for-exit IC card reader 10-2 are connected to the for-entrance terminal 11-1 and the for-exit terminal (accounting terminal) 11-2, respectively. The for-entrance terminal 11-1 and the for-exit terminal (accounting terminal) 11-2 form the facility terminal 11. Each facility user carries an IC card. When each user passes the IC card over the for-entrance IC card reader 10-1 or the for-exit IC card reader 10-2, an entrance time or an exit time, and an individual ID (identification) code recorded in the IC card are read. These read-out information are sent to the server 13 via the line 12 for use in later data processing. The server 13 is connected to the intranet 14 so that information can be disclosed in the congestion state display terminals 15-1, . . . , 15-N.

Now, the operation of this embodiment will be described.

In FIG. 1, each user passes the IC card 10-3 over the for-entrance IC card reader 10-1 at the entrance of the dining-hall 10. In this event, an entrance time and an individual ID code recorded in the IC card 10-3 are read. These read-out information are sent to the server 13 via the line 12 for use in later data processing. Thereafter, each user finishes eating or the like and then passes the IC card 10-3 over the for-exit IC card reader 10-2. Like upon entering, an exit time and the individual ID code recorded in the IC card 10-3 are read. These read-out information are sent to the server 13 via the line 12 for use in later data processing. Note that the for-exit terminal 11-2 can also be used as an accounting terminal for calculation of a meal charge.

Then, in FIG. 3 or 4, the individual ID codes, the entrance times, and the exit times are accumulated in the server 13. The server 13 performs data processing to prepare momentary congestion rates on the basis of the user capacity number of the dining-hall 10 as shown by the graph in FIG. 3 or 4.

The server 13 displays the prepared graph and so forth in the congestion state display terminals 15-1, . . . , 15-N via the intranet 14.

Each of the congestion state display terminals 15-1, . . . , 15-N can display not only current congestion state information but also past congestion state information by inputting a past date (year, month, day). Further, by inputting an individual ID code and a password of a user, it is possible to display his/her own using time zone.

Further, in FIG. 5, for the purpose of reducing the congestion rates of the dining-hall 10, a manager of the dining-hall 10 can carry out the following by the use of the server 13.

The server 13 stores congestion rate data on dining-hall operating days. When there is a time zone where the congestion rate of the dining-hall 10 exceeds a limit (e.g. 90%), the server 13 uses as a denominator the number of users (corresponding to a portion defined by vertical stripes in the graph of FIG. 5) who used such a time zone on that date, thereby calculating the number of users (corresponding to a portion surrounded by a square in the graph of FIG. 5) deletion of which can accomplish a reduction to a target congestion rate (e.g. 80%) or less. This number of users the deletion of which can achieve the reduction to the target congestion rate or less is called a time shift user number.

The server 13 extracts as many users as the time shift user number from the foregoing denominator and automatically transmits, on a later date, a notification recommending use of a non-congested time zone to each of the congestion state display terminals 15-1, . . . , 15-N of the extracted users by attaching image data in which an indication recommending use of a non-congested time zone is added in the graph showing the congestion state on that date along with a using time zone of those users. Note that the using time zone of those users is the time zone included between the right and left sides of the square in the graph of FIG. 5. Further, the indication recommending use of a non-congested time zone is given as the solid line arrow Ar starting from the right side of the square in the graph of FIG. 5.

It is possible to desirably set a limit congestion rate and an ideal congestion rate. Further, the foregoing notification can be transmitted to each of the congestion state display terminals 15-1, . . . , 15-N by, for example, e-mail. Moreover, it may be set to, for example, (1) transmit a result of each day the following day, or (2) transmit a result of each day one day prior to the same day of the next week.

According to the foregoing embodiment, it is possible to transmit the congestion state of the facility to users in real time to thereby recommend them to relieve the congestion of the facility.

Further, according to the foregoing embodiment, there is an effect that users of the facility shift their using times to non-congested time zones.

Specifically, by comparing the past congestion states of the facility in using time zones of respective dates, each user can use the facility by selecting his/her using time.

In addition, by disclosing the congestion relieving information to users from the facility manager side, it is possible to stabilize personnel allocation and equipment operation change for the facility management.

As another embodiment of the present invention, when, for example, it is necessary to confirm attendance at a lecture or the like in school or an educational facility, attendants can be easily confirmed by the use of the present invention.

1. A congestion state management device comprising a processor and a memory that stores a program for causing said processor to execute predetermined processing and also operates as a temporary storage during execution of said program by said processor, wherein said processor executes, as said predetermined processing:
a first step of storing in advance a user capacity number of a facility into said memory as a stored user capacity number;
a second step of, responsive to receipt of an entrance time of a user into said facility, an exit time of the user from said facility, and an identification code of the user transmitted from a facility terminal when the user uses said facility, storing said entrance time, said exit time, and said identification code of the user into said memory as stored data by associating them with each other;
a third step of processing said stored data by the use of said stored user capacity number to thereby prepare momentary congestion rates of said facility, storing said prepared momentary congestion rates along with a date into said memory, and causing a congestion state display terminal to display said prepared momentary congestion rates along with said date as a graph; and
a fourth step of, responsive to receipt of said identification code of the user and a past date that have been input by the user into said congestion state display terminal and transmitted from said congestion state display terminal, causing said congestion state display terminal to display as a past graph the congestion rates on said past date stored in said memory and further causing said congestion state display terminal to display as a using time zone of the user a period from said entrance time to said exit time of the user on said past date stored in said memory.

2. A congestion state management device according to claim 1, wherein said fourth step is a step of, responsive to receipt of said identification code of the user and a past date that have been input by the user into said congestion state display terminal and transmitted from said congestion state display terminal, causing said congestion state display terminal to display as a past graph the congestion rates on said past date stored in said memory and further causing said congestion state display terminal to display a period from said entrance time to said exit time of the user on said past date stored in said memory, as a using time zone of the user in said past graph.

3. A congestion state management device according to claim 1, wherein said fourth step is a step of, responsive to receipt of said identification code of the user and a past date that have been input by the user into said congestion state display terminal and transmitted from said congestion state display terminal, causing said congestion state display terminal to display as a past graph the congestion rates on said past date stored in said memory, further causing said congestion state display terminal to display a period from said entrance time to said exit time of the user on said past date stored in said memory, as a using time zone of the user in said past graph and, when said using time zone of the user includes a time zone exceeding a predetermined congestion rate, adding into said past graph an indication recommending use of a non-congested time zone.

4. A congestion state management device according to any one of claims 1 to 3, wherein said processor further executes a step of, when there is on a certain date a time zone where the congestion rate of said facility exceeds a predetermined congestion rate, automatically transmitting, on a later date, a notification recommending use of a non-congested time zone to each of congestion state display terminals of at least part of users who used such a time zone on that certain date, by attaching image data in which an indication recommending use of a non-congested time zone is added in a graph showing a congestion state of said facility on that certain date along with a using time zone of said users.

5. A congestion state management system comprising a facility terminal provided in a facility, a congestion state management device connected to said facility terminal, and a congestion state display terminal connected to said congestion state management device,
said congestion state management device comprising a processor and a memory that stores a program for causing said processor to execute predetermined processing and also operates as a temporary storage during execution of said program by said processor,
wherein said processor executes, as said predetermined processing:
a first step of storing in advance a user capacity number of a facility into said memory as a stored user capacity number;
a second step of, responsive to receipt of an entrance time of a user into said facility, an exit time of the user from said facility, and an identification code of the user transmitted from a facility terminal when the user uses said facility, storing said entrance time, said exit time, and said identification code of the user into said memory as stored data by associating them with each other;
a third step of processing said stored data by the use of said stored user capacity number to thereby prepare momentary congestion rates of said facility, storing said prepared momentary congestion rates along with a date into said memory, and causing a congestion state display terminal to display said prepared momentary congestion rates along with said date as a graph; and
a fourth step of, responsive to receipt of said identification code of the user and a past date that have been input by the user into said congestion state display terminal and transmitted from said congestion state display terminal, causing said congestion state display terminal to display as a past graph the congestion rates on said past date stored in said memory and further causing said congestion state display terminal to display as a using time zone of the user a period from said entrance time to said exit time of the user on said past date stored in said memory.

6. A congestion state management system according to claim 5, wherein said fourth step is a step of, responsive to receipt of said identification code of the user and a past date that have been input by the user into said congestion state display terminal and transmitted from said congestion state display terminal, causing said congestion state display terminal to display as a past graph the congestion rates on said past date stored in said memory and further causing said congestion state display terminal to display a period from said entrance time to said exit time of the user on said past date stored in said memory, as a using time zone of the user in said past graph.

7. A congestion state management system according to claim 5, wherein said fourth step is a step of, responsive to receipt of said identification code of the user and a past date that have been input by the user into said congestion state display terminal and transmitted from said congestion state display terminal, causing said congestion state display terminal to display as a past graph the congestion rates on said past date stored in said memory, further causing said congestion state display terminal to display a period from said entrance time to said exit time of the user on said past date stored in said memory, as a using time zone of the user in said past graph and, when said using time zone of the user includes a time zone exceeding a predetermined congestion rate, adding into said past graph an indication recommending use of a non-congested time zone.

8. A congestion state management system according to any one of claims 5 to 7, wherein said processor further executes a step of, when there is on a certain date a time zone where the congestion rate of said facility exceeds a predetermined congestion rate, automatically transmitting, on a later date, a notification recommending use of a non-congested time zone to each of congestion state display terminals of at least part of users who used such a time zone on that certain date, by attaching image data in which an indication recommending use of a non-congested time zone is added in a graph showing a congestion state of said facility on that certain date along with a using time zone of said users.

9. A recording medium in which a program has been recorded, said program being for a congestion state management device comprising a processor and a memory that stores the program and for causing said processor to execute predetermined processing, wherein said predetermined processing executed by said program comprises:
a first step of storing in advance a user capacity number of a facility into said memory as a stored user capacity number;
a second step of, responsive to receipt of an entrance time of a user into said facility, an exit time of the user from said facility, and an identification code of the user transmitted from a facility terminal when the user uses said facility, storing said entrance time, said exit time, and said identification code of the user into said memory as stored data by associating them with each other;
a third step of processing said stored data by the use of said stored user capacity number to thereby prepare momentary congestion rates of said facility, storing said prepared momentary congestion rates along with a date into said memory, and causing a congestion state display terminal to display said prepared momentary congestion rates along with said date as a graph; and
a fourth step of, responsive to receipt of said identification code of the user and a past date that have been input by the user into said congestion state display terminal and transmitted from said congestion state display terminal, causing said congestion state display terminal to display as a past graph the congestion rates on said past date stored in said memory and further causing said congestion state display terminal to display as a using time zone of the user a period from said entrance time to said exit time of the user on said past date stored in said memory.

10. A recording medium according to claim 9, wherein said fourth step is a step of, responsive to receipt of said identification code of the user and a past date that have been input by the user into said congestion state display terminal and transmitted from said congestion state display terminal, causing said congestion state display terminal to display as a past graph the congestion rates on said past date stored in said memory and further causing said congestion state display terminal to display a period from said entrance time to said exit time of the user on said past date stored in said memory, as a using time zone of the user in said past graph.

11. A recording medium according to claim 9, wherein said fourth step is a step of, responsive to receipt of said identification code of the user and a past date that have been input by the user into said congestion state display terminal and transmitted from said congestion state display terminal, causing said congestion state display terminal to display as a past graph the congestion rates on said past date stored in said memory, further causing said congestion state display terminal to display a period from said entrance time to said exit time of the user on said past date stored in said memory, as a using time zone of the user in said past graph and, when said using time zone of the user includes a time zone exceeding a predetermined congestion rate, adding into said past graph an indication recommending use of a non-congested time zone.

12. A program according to any one of claims 9 to 11, wherein said predetermined processing further comprises a step of, when there is on a certain date a time zone where the congestion rate of said facility exceeds a predetermined congestion rate, automatically transmitting, on a later date, a notification recommending use of a non-congested time zone to each of congestion state display terminals of at least part of users who used such a time zone on that certain date, by attaching image data in which an indication recommending use of a non-congested time zone is added in a graph showing a congestion state of said facility on that certain date along with a using time zone of said users.
